(19) United States
(12) Patent Application Publication
(10) Pub. No.: US 2024/0346494 A1
(43) Pub. Date: Oct. 17, 2024

(54) METHOD AND APPARATUS FOR ONLINE BIDDING, DEVICE, AND MEDIUM

(71) Applicant: Beijing Youzhuju Network Technology Co., Ltd., Beijing (CN)

(72) Inventors: Yinsong XUE, Beijing (CN); Bonan NI, Beijing (CN); Yiqing WANG, Beijing (CN); Junjie SHI, Beijing (CN); Liangni LU, Beijing (CN)

(21) Appl. No.: 18/755,518

(22) Filed: Jun. 26, 2024

Related U.S. Application Data
(63) Continuation of application No. PCT/CN2023/077513, filed on Feb. 21, 2023.

(30) Foreign Application Priority Data
Mar. 15, 2022 (CN) 202210254370.2

(51) Int. Cl. G06Q 20/38; G06Q 30/08

(52) U.S. Cl. CPC G06Q 20/3825; G06Q 30/08

(57) ABSTRACT

A method and apparatus for online bidding, a device, and a medium is provided according to the embodiments of the present disclosure. According to the method, encrypted information from a verification device of a bidding event is received at a participation device of the bidding event. The participation device transmits verification information associated with a bid of the bidding event to a management device of the bidding event. The participation device receives a first signature and a verification information set from the management device. The verification information set includes at least an association relation between the participation device and the verification information. The first signature is generated by the verification device for the verification information set. The participation device verifies a bidding process of the bidding event based on the first signature, the verification information set and the encrypted information.

### CROSS-REFERENCE TO RELATED APPLICATION(S)

This application is a Continuation Application of International Patent Application No. PCT/CN2023/077513, filed Feb. 21, 2023, which claims the benefit of priority to Chinese Invention patent application Ser. No. 20/221,0254370.2, filed on Mar. 15, 2022, and entitled “Method and apparatus for online bidding, device, and medium”, which are incorporated in its entirety herein by reference.

### FIELD

Example embodiments of the disclosure generally relate to the field of computers, and particularly relate to a method and apparatus for online bidding, a device, and a computer-readable storage medium.

### BACKGROUND

As information technologies grow, people can meet various display contents in daily life, such as text or video advertisements. These display contents can guide people to acquire corresponding objects, such as various goods, digital contents or specific services.

At present, plenty of object providers expect to display their goods, services or other objects at promoters (such as websites and mobile terminal applications (App)) such that the provided objects can be better known by users, thereby guiding more users to acquire these objects. For instance, a winner can be selected from a plurality of object providers by way of online bidding. The promoters can display contents related to the winner or its provided objects in display positions. However, various cheating behaviors sometimes occur in a bidding process, which is undesired.

### SUMMARY

According to an embodiment of the disclosure, a solution for online bidding is provided.

In a first aspect of the disclosure, a method for online bidding is provided. The method includes: receiving encrypted information from a verification device of a bidding event at a participation device of the bidding event; transmitting, by the participation device, verification information associated with a bid for the bidding event to a management device of the bidding event; and receiving, by the participation device, a first signature and a verification information set from the management device. The verification information set includes at least an association relation between the participation device and the verification information. The first signature is generated by the verification device for the verification information set. The participation device verifies a bidding process of the bidding event based on the first signature, the verification information set and the encrypted information.

In a second aspect of the disclosure, a method for online bidding is provided. The method includes: receiving, at a management device of a bidding event, respective verification information of each of a group of participation devices of the bidding event that is associated with a bid of the bidding event; and generating, by the management device, a verification information set based on the respective verification information of each of the group of participation devices. The verification information set includes an association relation between the respective verification information of each of the group of participation devices and a corresponding participation device. The management device transmits the verification information set to a verification device of the bidding event. The management device receives a first signature from the verification device. The first signature is generated by the verification device for the verification information set. The management device transmits the first signature and the verification information set to the group of participation devices.

In a third aspect of the disclosure, a method for online bidding is provided. The method includes transmitting, at a verification device of a bidding event, encrypted information of the verification device to a group of participation devices of the bidding event; and receiving, by the verification device, a verification information set from a management device of the bidding event. The verification information set includes an association relation between respective verification information of each of the group of participation devices and a corresponding participation device. The verification device generates a first signature based on the verification information set and by using additional encrypted information associated with the encrypted information. The verification device transmits the first signature to the management device.

In a fourth aspect of the disclosure, an electronic device is provided. The device includes at least one processing unit; and at least one memory. The at least one memory is coupled to the at least one processing unit and stores an instruction configured to be executed by the at least one processing unit. When executed by the at least one processing unit, the instruction causes the device to execute the method according to the first aspect, the second aspect or the third aspect.

In a fifth aspect of the disclosure, an apparatus for online bidding is provided. The apparatus includes an encrypted information reception module configured to receive encrypted information from a verification device of a bidding event. The apparatus further includes a verification information transmission module configured to transmit verification information associated with a bid for the bidding event to a management device of the bidding event. The apparatus further includes a first signature reception module configured to receive a first signature and a verification information set from the management device. The verification information set includes at least an association relation between the apparatus and the verification information. The first signature is generated by the verification device for the verification information set. The apparatus further includes a verification module configured to verify a bidding process of the bidding event based on the first signature, the verification information set and the encrypted information.

In a sixth aspect of the disclosure, an apparatus for online bidding is provided. The apparatus includes a verification information reception module configured to receive respective verification information of each of a group of participation devices of a bidding event that is associated with a bid for the bidding event. The apparatus further includes a verification information set generation module configured to generate a verification information set based on the respective verification information of each of the group of participation devices. The verification information set includes an association relation between the respective verification information of each of the group of participation devices and a corresponding participation device. The apparatus further includes a verification information set transmission module configured to transmit the verification information set to a verification device of the bidding event. The apparatus further includes a first signature reception module configured to receive a first signature from the verification device. The first signature is generated by the verification device for the verification information set. The apparatus further includes a first signature transmission module configured to transmit the first signature and the verification information set to the group of participation devices.

In a seventh aspect of the disclosure, an apparatus for online bidding is provided. The apparatus includes an encrypted information transmission module configured to transmit encrypted information of the apparatus to a group of participation devices of a bidding event. The apparatus further includes a verification information set reception module configured to receive a verification information set from a management device of the bidding event. The verification information set includes an association relation between the respective verification information of each of the group of participation devices and a corresponding participation device. The apparatus further includes a first signature generation module configured to generate a first signature based on the verification information set and by using additional encrypted information associated with the encrypted information. The apparatus further includes a first signature transmission module configured to transmit the first signature to the management device.

In an eighth aspect of the disclosure, a computer-readable storage medium is provided. The medium has a computer program stored thereon. When executed by a processor, the program implements the method according to the first aspect and/or the second aspect and/or the third aspect.

It should be understood that a description in the summary is neither intended to limit key features or important features of embodiments of the disclosure, nor intended to limit the scope of the disclosure. Other features of the disclosure will become easy to understand through the following descriptions.

### BRIEF DESCRIPTION OF THE DRAWINGS

The above and other features, advantages and aspects of various embodiments of the disclosure will become more apparent in combination with accompanying drawings and with reference to the following detailed descriptions. In the figures, the same or similar reference numerals denote the same or similar elements, where:

FIG. 1 shows a schematic diagram of an example environment in which an embodiment of the disclosure can be implemented;

FIG. 2 shows a schematic diagram of a signaling flow for online bidding according to an embodiment of the disclosure;

FIG. 3 shows a schematic diagram of examples of a coded representation and a hash chain of a bid according to an embodiment of the disclosure;

FIG. 4 shows a schematic diagram of a signaling flow for offline verification of online bidding according to an embodiment of the disclosure;

FIG. 5 shows a flow diagram of an example process for online bidding according to an embodiment of the disclosure;

FIG. 6 shows a flow diagram of another example process for online bidding according to an embodiment of the disclosure;

FIG. 7 shows a flow diagram of yet another example process for online bidding according to an embodiment of the disclosure;

FIG. 8 shows a schematic structural block diagram of an apparatus for online bidding according to some embodiments of the disclosure;

FIG. 9 shows a schematic structural block diagram of another apparatus for online bidding according to some embodiments of the disclosure;

FIG. 10 shows a schematic structural block diagram of yet another apparatus for online bidding according to some embodiments of the disclosure; and

FIG. 11 shows a block diagram of a device capable of implementing a plurality of embodiments of the disclosure.

### DETAILED DESCRIPTION OF EMBODIMENTS

Embodiments of the disclosure will be described in more detail below with reference to accompanying drawings. Although some embodiments of the disclosure are shown in accompanying drawings, it should be understood that the disclosure can be implemented in various forms and should not be construed as being limited to the embodiments stated herein. On the contrary, these embodiments are provided such that the disclosure can be understood more thoroughly and completely. It should be understood that accompanying drawings and embodiments of the disclosure are for example purposes only and are not intended to limit the scope of protection of the disclosure.

In the descriptions of embodiments of the disclosure, the term “include” and its similar terms should be interpreted as open inclusion, that is, “including but not limited to”. The terms “on the basis of” and “based on” should be interpreted as “at least partially on the basis of” and “at least partially based on”. The term “an embodiment” or “the embodiment” should be interpreted as “at least one embodiment”. The term “some embodiments” should be interpreted as “at least some embodiments”. Other explicit and implicit definitions may further be included below.

As mentioned above, plenty of object providers desire to display their goods, services or other objects at promoters (such as websites and mobile terminal applications (App)) such that the provided objects can be better known by users, thereby guiding more users to acquire these objects. A plurality of object providers may participate in a bidding event initiated by a promoter through respective participation devices. A bidding result of a bidding event may be determined by a management device. The bidding result may indicate a winning device of a plurality of participation devices participating in the bidding event. The promoter may display contents related to the winning device or its provided object at display positions.

At present, an online bidding mechanism based on a sealed price is proposed. Each time a user opens a promoter (such as a website or an application), a bidding event for a display position (such as an advertisement position) is triggered. According to the bidding mechanism based on a sealed price, all participation devices simultaneously submit sealed complete bids to the management device of the bidding event. The participation devices do not know bids of each other. After receiving the bids from all the participation devices, the management device determines, according to the sealed bids submitted by all the participation devices, a winning device and a price required to be given by the winning device. For instance, the management device may determine a participation device having a highest sealed bid as the winning device.

However, some cheating behaviors exist in these conventional bidding solutions based on sealed bids. In the conventional online bidding solutions, communication between a promoter and participants (that is, participation devices) and computation of a bidding process are executed in dependence on a management device as an intermediary. Therefore, if the management device has attacks and cheating behaviors, for instance, executes false bidding processes and transmits different false results to different participation devices, cheating behaviors and data security problems will be caused in such conventional online bidding processes.

For instance, the management device itself may participate in bidding, and the participation device in this case is also referred to as an own participation device. That is, the management device colludes with the own participation device to cheat. Such a collusive cheating behavior is also referred to as Last Look cheating. Taking first-price sealed bidding in which a bid of a winner is taken as the price to be paid by the winner as an example, assuming that an original bid of the own participation device is 1.5 yuan, and the management device finds that the highest bid of a participation device of a bidding competitor is only 1.0 yuan, the management device will collude with the own participation device, for instance, modify the original bid to 1.1 yuan. As a result, a seller of the bidding event, such as a promoter of a display position, will lose earnings of 0.4 yuan. Such a cheating behavior violates rules of the first-price sealed bidding and is unfair to competitors.

An example in which the management device colludes with the participation device to cheat is described above. In some scenarios, the management device also colludes with a promoter initiating a bidding event (such as, a display position promoter) to cheat. For instance, taking second-price sealed bidding in which a bid of a second winner is taken as the price to be paid by a winner as an example, assuming that the management device finds that the bid of the winner (a participation device giving a highest bid) is 1.5 yuan, and the bid of the second winner (a participation device giving a second highest bid) is 1.0 yuan, the promoter would have earned 1.0 yuan. However, the management device may lie to all participation devices about the bid of the second winner being 1.4 yuan such that earnings of the promoter can be increased to 1.4 yuan. Such a cheating behavior abnormally increases the earnings of the promoter and is unfair to participants.

In addition, such a conventional online bidding solution based on a sealed bid cannot ensure information security of the participation devices. Bid information of the participation devices is business privacy and required to be prevented from being leaked. On the one hand, a bid of a participation device for each particular bidding event, such as, a bid for a bidding event of a specific advertisement position or specific traffic, represents a value assessment of a corresponding participant for traffic of the advertisement position. On the other hand, a large amount of bidding data left by the participation device in long-term bidding for a promoter (or an advertisement platform) may expose a long-term bidding strategy of the participant, etc.

In a conventional bidding solution based on a sealed bid, the participation devices expose complete bid information to the management device, causing a risk of leakage of business privacy of the participation devices. On the one hand, the management device may sell private bid information of the participation devices. On the other hand, the participation devices may abandon bidding, submit false bids or use complex bidding strategies out of consideration of protecting business privacy, resulting in low bidding efficiency. In addition, the management device may collude or cheat with some participation devices or the promoter to control a bidding market. If the bid information of the participation device is leaked to a competitor, the competitor will design a corresponding strategy by analyzing the bid information. In such a case, a bid of the participation device will be increased and an unfair bidding result will be caused.

To sum up, there is a lack of effective means to verify the correctness and fairness of the conventional online bidding solution, and a lack of effective data privacy protection. Such online bidding causes efficiency reduction and ecological degradation of an internet bidding market (such as an advertisement market).

Various cheating behaviors and information leakage problems in conventional online bidding solutions are described in the above examples. According to embodiments of the disclosure, a solution for online bidding is provided to solve one or more of the above problems and other potential problems. In the solution, encrypted information from a verification device of a bidding event is received at a participation device of the bidding event. A participation device receives a first signature and a verification information set from a management device of the bidding event. The verification information set includes at least an association relation between the participation device and verification information of the participation device. The verification information is associated with a bid of the participation device for the bidding event. The first signature is generated by the verification device for the verification information set. The participation device verifies a bidding process of the bidding event based on the received first signature and verification information set and the encrypted information of the verification device.

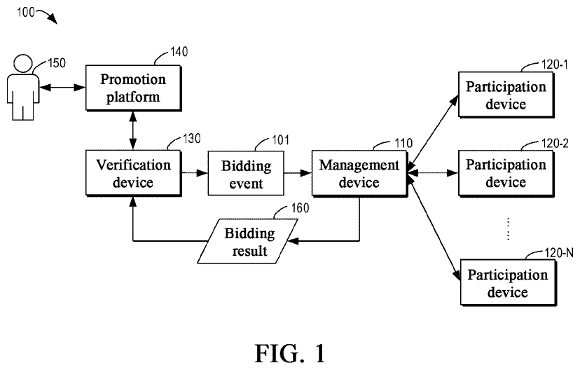

According to an embodiment of the disclosure, a verification information set is signed by a verification device. The participation device may verify information transmitted by the management device using the verification information of the verification device and the received first signature and verification information set. By introducing the verification device to sign information transmitted between the management device and the participation device, various cheating behaviors in the bidding process can be avoided. Particularly, collusive cheating between the management device and a participation device or between the management device and the verification device can be avoided. A solution of managing and participating in bidding according to the disclosure will be described below in combination with FIG. 1 to FIG. 11.

### Example Environments

FIG. 1 shows a schematic diagram of an example environment 100 in which an embodiment of the disclosure can be implemented. In the environment 100 in FIG. 1, a management device 110 is configured to execute a bidding process (also referred to as an auction process) for a bidding event 101. Herein, the management device 110 is also referred to as an “auctioneer device”, an “intermediary device” or an “advertisement exchange (ADX)”. The bidding event 101 is also referred to as an “auction event”.

In some embodiments, the management device 110 is configured to receive, from the verification device 130, a request to execute the bidding event 101. Herein, the verification device 130 is also referred to as a supply-side platform (SSP) or a supply-side device. The verification device 130 is configured to be in communication with a promotion platform 140 (also referred to as a promoter, a display position provider or a display position developer). In some embodiments, the verification device 130 may also be integrated into the promotion platform 140. Additionally or alternatively, the verification device 130 may also be a device running a trusted agent program serving the promotion platform 140. Examples of the promotion platform 140 include but are not limited to a website, a mobile terminal application (App), etc. For instance, the promotion platform 140 may be a video website, etc. that provides an online advertisement position. The bidding event 101 may be an event for online bidding for an advertisement position on the video website.

In some embodiments, the promotion platform 140 may interact with a user 150. For instance, the user 150 may access the promotion platform 140. In a process that the promotion platform 140 displays contents such as a page for the user 150, for a display position (such as an advertisement position) in the page, the promotion platform 140 may transmit, to the verification device 130, a request for a bidding event of the display position. In some embodiments, the promotion platform 140 may further transmit information of the display position, additional user information and/or cookie, etc. to the verification device 130.

The verification device 130 is configured to transmit a request for the bidding event 101 to the management device 110. Alternatively or additionally, the verification device 130 may further transmit the information of the display position, the additional user information and/or cookie, etc. to the management device 110. The verification device 130 may interact with the management device 110 through a secure channel, for instance, to transmit various information.

In response to receiving the request for the bidding event 101, the management device 110 may organize and manage a bidding process and/or a verification process of the bidding event 101. For instance, the management device 110 may publish information about the bidding event 101, such as the information of the display position, the additional user information and/or cookie, etc.

In response to receiving the information about the bidding event 101 that is published by the management device 110, a plurality of object providers intending to participate in the bidding event 101 may participate in the bidding event 101. For instance, the object provider may evaluate the traffic of the display position according to the information of the display position, the user information and/or cookie, etc. to determine whether to participate in the bidding event 101. In the bidding event 101 for the display position (such as an advertisement position), a plurality of object providers intending to display goods or service objects on the display position may choose to participate in the bidding event 101.

An object provider (also referred to as a “participant” or “bidder”) intending to participate in the bidding event 101 may participate in the bidding event 101 through its own device or an external device. In some embodiments, the participation device 120 may be a device running a trusted agent program serving the object provider. Herein, the device participating in the bidding event 101 may be referred to as a “participation device”, an “object provider device”, a “bidding device” or a “demand-side platform (DSP)”. In an example of FIG. 1, participation devices 120-1, 120-2, . . . and 120-N (where Nis an integer greater than or equal to 1) are a group of participation devices 120 intending to participate in the bidding event 101. Each participation device 120 corresponds to a corresponding participant. The participation devices 120 compete with each other. For ease of discussion, participation devices 120-1, 120-2, . . . and 120-N, etc. may be collectively or individually referred to as participation device(s) 120. In an example of an advertisement position of a video website, the plurality of participation devices 120 may be participation devices 120 intending to publish advertisements on the advertisement position. In some embodiments, the management device 110 may interact with a plurality of participation devices 120. For instance, the management device 110 may be configured to transmit information about the bidding event 101 to various participation devices 120. In some embodiments, the management device 110 is further configured to receive bid information about the bidding event 101 from various participation devices 120.

The management device 110 is configured to determine a bidding result 160 for the bidding event 101. For instance, the management device 110 may determine the bidding result 160 based on the received bid information of a group of participation devices 120. Alternatively or additionally, the management device 110 is further configured to transmit the bidding result 160 to at least one participation device 120. For instance, the bidding result 160 may indicate at least a winning device of the plurality of participation devices 120 for the bidding event 101. The winning device may be a participation device 120 of the plurality of participation devices 120 that gives the highest bid. Herein, an object provider associated with the winning device is also referred to as a “winner”, and the winning device is also referred to as a “winner device”.

The winning device in the participation devices 120 may transmit its object (such as an advertisement link or other materials) to the management device 110, and pay the bid required to be given thereby. The management device 110 may transmit the object (such as the advertisement link or other materials) and the paid price of the winning device to the verification device 130, and the verification device 130 transmits the object (such as the advertisement link or other materials) and the paid price to the promotion platform 140. The promotion platform 140 displays the object (such as the advertisement link or other materials) of the winning device on the display position of the promotion platform 140 for viewing by the user 150.

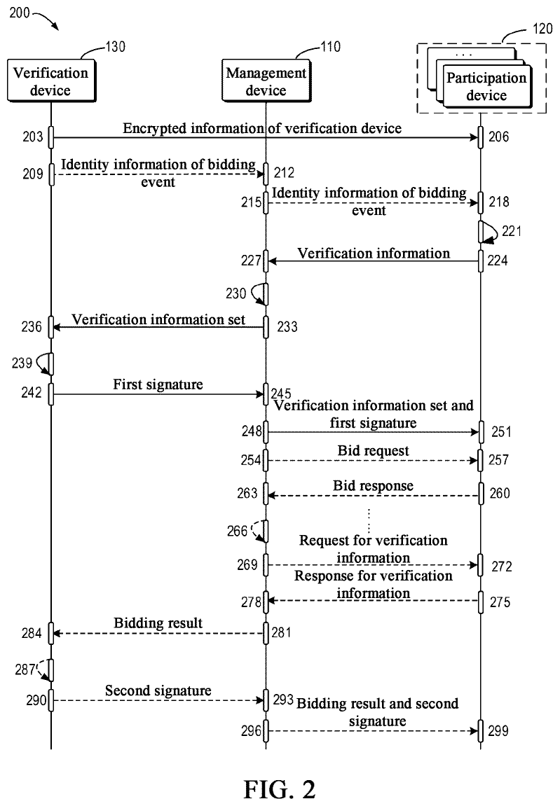

In some embodiments, the management device 110 is further configured to transmit the bidding result 160 to the verification device 130. The verification device 130 may sign the bidding result 160. The management device 110 is also configured to transmit other information to the verification device 130, such as verification information from the participation device 120 or a verification result for the bidding result 160 of the participation device 120. The verification device 130 may sign the above various information or other information, and may transmit signatures to the participation device 120 via the management device 110. Information transmission between the management device 110, the participation device 120 and the verification device 130 will be described in more detail below in combination with FIG. 2 to FIG. 11.

The management device 110, the participation device 120 and the verification device 130 in FIG. 1 may be implemented as any system or device having computing power, such as various computing devices/systems, terminal devices, servers, etc. The terminal device may be any type of mobile terminal, fixed terminal or portable terminal, including a mobile phone, a desktop computer, a laptop computer, a notebook computer, a netbook computer, a tablet computer, a media computer, a multi-media tablet, or any combination thereof, including accessories and peripherals of these devices, or any combination thereof. The servers include but are not limited to mainframes, edge computing nodes, computing devices in cloud environments, etc.

It should be understood that components and arrangements in the environment shown in FIG. 1 are examples only. An environment or system suitable for implementing the embodiments described in the disclosure can include one or more different components, other components, and/or different arrangements.

### Online Bidding With Verification Device

FIG. 2 shows a schematic diagram of a signaling flow 200 for online bidding according to an embodiment of the disclosure. The signaling flow 200 relates to the management device 110, the participation device 120 and the verification device 130 in the environment 100. It should be understood that the signaling flow 200 may relate to any number of management devices 110, any number of participation devices 120 and any number of verification devices 130.

In an operation, the verification device 130 transmits (203) encrypted information of the verification device 130 to a group of participation devices 120. For instance, before initiating the bidding event 101, the verification device 130 may synchronize, with the participation devices 120, the encrypted information used by the verification device 130. The encrypted information may be a public key of the verification device 130. In some embodiments, different encrypted information may be used for different bidding events 101. Alternatively or additionally, the verification device 130 may use the same encrypted information in a period of time. When the verification device 130 updates the encrypted information, the verification device 130 synchronizes the updated encrypted information with the participation devices 120. This verification information may be published or transmitted to the participation devices 120 through a public channel, for instance.

In some embodiments, no secure encrypted channel exists between the verification device 130 and the participation device 120 such that various information such as verification information, bid information and a bidding result described below cannot be directly transmitted between the verification device 130 and the participation device 120.

In some embodiments, the verification device 130 is configured to transmit (209) identity information of the bidding event 101 to the management device 110. The identity information of the bidding event 101 may include a query identifier (query_id) of the bidding event 101. For instance, query_id may be generated by Hash (query information), where Hash ( ) may be any suitable hash function, and query information is information (such as display position information and user information) related to the bidding event 101. Further, query_id may be a unique identifier of the bidding event 101. The identity information of the bidding event 101 may also be a random string (public_rnd) generated by the verification device 130 according to an arbitrary rule.

The management device 110 may transmit (215) the received (212) identity information of the bidding event 101 to a group of participation devices 120. For instance, the management device 110 may transmit (215) at least one of received (212) query_id and/or public_rnd to any participation device 120 of the group of participation devices 120.

Additionally, the management device 110 may further receive additional information about the bidding event 101 from the verification device (130) and transmit the additional information to the group of participation devices 120. The additional information may include a bidding object or a bidding rule of the bidding event 101, etc. The participation device 120 chooses, according to the received additional information of the bidding event 101, whether to participate in the bidding event 101. The bidding rule included in the additional information may indicate a coded representation of a bid required to be used by the participation device 120 and/or a type of bidding in which the participation device 120 participates, such as first-price bidding or second-price bidding. The first-price bidding and the second-price bidding will be described in detail below.

In some embodiments, a participation device 120 intending to participate in the bidding event 101 generates (221) verification information associated with a bid for the bidding event 101. The original bid of the participation device 120 is also referred to as a sealed bid. For instance, the participation device 120 may generate verification information such as Hash (bid) using any suitable hash function and based on the bid. For another instance, the participation device 120 may generate verification information based on the received (218) identity information for the bidding event 101 and the bid of the participation device 120.

In some embodiments, the participation device 120 may generate a first hash value based on the identity information of the bidding event 101, identity information of the participation device 120, and the bid. The participation device 120 further generates the verification information based on the first hash value. The identity information of the participation device 120 may be an identifier (such as bidder_id) of the participation device 120 in a group of participation devices 120 and/or private random string, rnd, generated by the participation device 120, etc. For instance, the first hash value may be generated using equation (1) as follows:

$$C 1 \_i = Hash ( bid\_i ‖ rnd\_i ‖ i ‖ public\_rnd ) \qquad ( 1 )$$

In equation (1), i represents the ith participation device 120 of a group of participation devices 120, C1_i represents a first hash value generated by the ith participation device 120, bid_i represents a bid of the ith participation device 120, rnd_i represents a private random string of the ith participation device 120, public_rnd represents a random string transmitted by the verification device 130 to the management device 110, “∥” represents a string concatenator, and Hash ( ) represents a hash function. It should be understood that an embodiment of the disclosure may employ any suitable hash function. The scope of the disclosure is not limited in this aspect.

Additionally or alternatively, the participation device 120 may generate a second hash value based on the identity information of the bidding event 101, the identity information of the participation device 120, and the coded representation of the bid. The participation device 120 further generates the verification information based on the second hash value. For instance, the participation device 120 may determine the coded representation of the bid for the bidding event 101. For instance, the participation device 120 may determine a binary representation of the bid as the coded representation. The binary representation has a predetermined length. That is, the coded representations of all the participation devices 120 have the same predetermined length. If a binary representation of a bid of a participation device 120 does not reach a predetermined length, 0 may be complemented at a position of the binary representation not reaching the predetermined length.

Alternatively, the participation device 120 may further determine any other carry system representation of the bid, such as a ternary representation and a quinary representation, as the coded representation of the bid. In some embodiments, the participation device 120 may further generate a coded representation of the bid of using a dynamic carry system representation. For instance, on the one hand, octonary coding can be carried out on a portion of the bid exceeding a price threshold (such as one thousand, ten thousand or any other numerical value). On the other hand, binary coding can be carried out on a portion of the bid not exceeding the price threshold. It should be understood that different carry system coding modes enumerated herein are exemplary merely and not limitative. Embodiments of the disclosure are not limited in this respect.

Taking a coded representation of a binary representation as an example, the second hash value may be generated using equation (2) as follows:

$$C 2 \_i = Hash ( bid2\_i ‖ rnd\_i ‖ i ‖ public\_rnd ) \qquad ( 2 )$$

In equation (2), i represents the ith participation device 120 of a group of participation devices 120, C2_i represents the second hash value generated by the ith participation device 120, bid2_i represents a coded representation (such as a binary representation) of a bid of the ith participation device 120, rnd_i represents a random string of the ith participation device 120, public_rnd represents a random string of the management device 110, “∥” represents a string concatenator, and Hash ( ) represents a hash function. It should be understood that an embodiment of the disclosure may employ any suitable hash function. The scope of the disclosure is not limited in this aspect.

In some embodiments, the participation device 120 may further generate a hash chain associated with the coded representation based on the identity information of the bidding event 101, the identity information of the participation device 120, and the coded representation of the bid. The hash chain includes a group of hash values corresponding to positions of the coded representation and a third hash value other than the group of hash values. The participation device 120 further generates the verification information based on the third hash value. For instance, the participation device 120 may generate a start hash value at a start position of the hash chain based on the received (218) identity information of the bidding event 101 and identity information of the participation device 120. The start hash value corresponds to the position of a least significant bit of the coded representation. In some embodiments, the participation device 120 may generate a second hash value corresponding to a second position in the hash chain based on a first value located at a first position in the coded representation and a first hash value corresponding to the first position in the hash chain. The second position is an adjacent higher bit of the first position.

In some embodiments, the start hash value of the hash chain may be generated using equation (3) as follows:

$$H\_i [ 0 ] = Hash ( i ‖ query\_id ‖ rnd\_i ) \qquad [ 3 ]$$

In the equation, i represents an identifier of the ith participation device 120 of a group of participation devices 120, H_i[0] represents a start hash value of a hash chain H of the ith participation device 120, start hash value H_i[0] corresponds to a position of least significant bit, bid2_i[1], of a coded representation of the ith participation device 120, query_id represents identity information of the bidding event 101, rnd_i represents identity information (that is, a random string) of the ith participation device 120, “∥” represents a string concatenator, and Hash ( ) represents a hash function, such as a one-way hash function. It should be understood that an embodiment of the disclosure may employ any suitable hash function. The scope of the disclosure is not limited in this aspect.

By determining the start hash value using identifier i of the participation device 120, identity information (query_id and rnd_i) of the bidding event 101, etc., it can be ensured that the hash value is generated based on information of a plurality of parties (a plurality of devices). In this way, the hash value can be prevented from being forged or tampered. In addition, subsequent hash values in the hash chain can also be prevented from being forged or tampered with.

After start hash value H_i[0] is determined, the remaining hash values of the hash chain H can be determined in turn in a case of 1≤t≤M, where M represents a length of the coded representation. It should be understood that M can be any natural number greater than or equal to 1, and a value of M is related to a value range of the bid. For instance, the remaining hash values may be determined using equation (4) as follows:

$$H\_i [ t ] = Hash ( bid2\_i [ t ] ‖ H\_i [ t - 1 ] ‖ i ‖ query\_id ) \qquad ( 4 )$$

In the equation, H_i[t] represents the (t+1) th hash value of a hash chain H of an ith participation device 120, and H_i[t−1] represents a tth hash value of the hash chain H. That is, H_i[t] corresponds to a position of a (t+1) th bit (bid2_[t+1]) from low to high of the coded representation of the ith participation device 120, where bid2_i[t] represents a value of a tth bit from low to high of the coded representation of the ith participation device 120.

In some embodiments, such as embodiments in which the hash chain H is determined according to equation (3) and equation (4) mentioned above, the length of the hash chain His one more than the length of a coded representation, bid. The hash chain H includes a group of hash values corresponding to positions of coded representation, bid, and third hash value, H[M], (also referred to as a reference hash value) other than the group of hash values. The participation device 120 may generate the verification information based on the third hash value H[M]. Additionally, the participation device 120 may further determine a hash value other than the third hash value in the hash chain H as additional verification information. The participation device 120 may transmit (224) the additional verification information and the verification information to the management device 110.

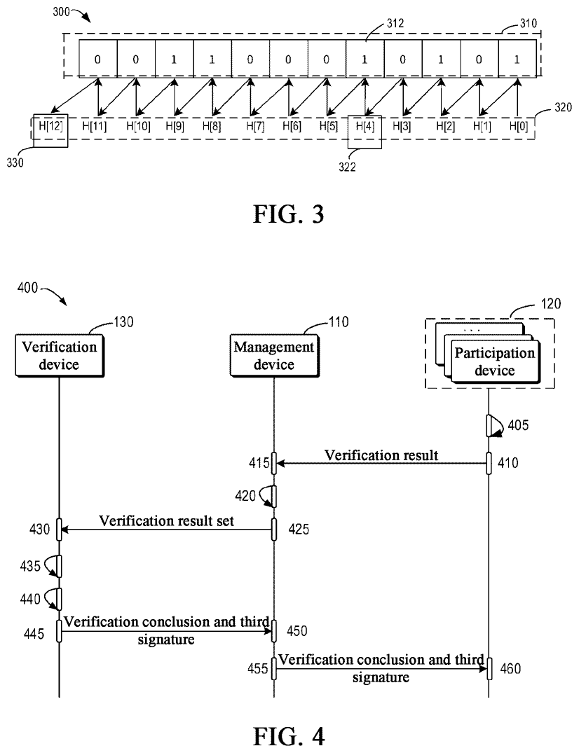

FIG. 3 shows a schematic diagram of an example 300 of a coded representation and a hash chain of a bid according to an embodiment of the disclosure. In the example 300, the coded representation 310 of the bid of the participation device 120 is a binary representation. The coded representation 310 is “001100010101”, which may be configured to represent a bid of 789. The coded representation 310 has a length M of 12. The hash chain 320 includes H[0]- H[12], 13 hash values in total. Further, H[0]-H[11] correspond to positions of the coded representation 310, respectively. For instance, the hash value 322 (that is, H[4]) corresponds to a position 312 (which has a value of 1) of the coded representation 310. Further, H[12] is a hash value 330 at an end position of the hash chain 320, and is also referred to as a third hash value 330 or a reference hash value.

Taking a 3rd participation device 120 of a group of participation devices 120 as an example (that is, i=3). Assuming that identity information (such as rnd) is “a0b1c2” and identity information (such as query_id) of the bidding event 101 is “query123”. In this example, start hash value H_3[0] of the hash chain H generated using equation (1) mentioned above may be Hash (“3”∥“query_123”∥“a0b1c2”). Assuming that the coded representation of the 3rd participation device 120 is a coded representation 310 in FIG. 3, each value of the hash chain 320 in FIG. 3 may be H[0]=Hash(“3”∥“query_123”∥“a0b1c2”), H[1]=Hash(1∥H[0]∥“3”∥“query_123”), . . . , H[12]=Hash(0∥H[11]∥“3”∥“query_123”).

Several methods through which the participation device 120 generates the verification information are described in detail above. In some embodiments, the participation device 120 may generate output <verification information, additional verification information> using a predefined verification information generation program and based on input <bid, rnd, bidder_id, query_id, public_rnd>. In the above function, bid represents a bid or a coded representation (such as a binary representation) of the bid of the participation device 120 for the bidding event 101, bidder_id represents an identifier of the participation device 120, and rnd represents a private random string generated by the participation device 120. The identity information of the participation device 120 may include bidder_id and/or rnd, and query_id and public_rnd represent identity information of the bidding event 101. The function can be used to generate other additional verification information besides the verification information. The additional verification information may be, for instance, one or more hash values in the hash chain described above. The predefined verification information generation program may be designed based on various methods for generating the verification information described above.

It should be understood that the processes of generating the verification information enumerated herein are merely exemplary and not limitative. The scope of the disclosure is not limited in this aspect.

With further reference to FIG. 2, the participation device 120 transmits (224) the generated (221) verification information to the management device 110. The management device 110 generates (230) a verification information set based on the received (227) respective verification information of each of a group of participation devices 120 and optional additional verification information. For instance, the management device 110 may receive respective identity information (such as bidder_id and/or rnd) of each of the group of participation devices 120. The management device 110 may generate the verification information set based on respective verification information and respective identity information of each of the group of participation devices 120. The verification information set includes an association relation between respective verification information (and optional additional verification information) of each of the group of participation devices 120 and identity information of a corresponding participation device 120. For instance, mapping of identity information bidder_id and verification information bid_hash (such as a {bidder_id: bid_hash} dictionary) may be generated as a verification information set using an information packaging program based on respective identity information bidder_id and verification information bid_hash of each of the group of participation devices 120.

The management device 110 is configured to transmit (233) the generated (230) verification information set to the verification device 130. The verification device 130 generates (239) a first signature using additional encrypted information associated with encrypted information and based on the received (236) verification information set. For instance, the encrypted information may be a public key of the verification device 130, and the additional encrypted information may be a private key of the verification device 130.

The verification device 130 transmits (242) the generated (239) first signature to the management device 110. The management device 110 is configured to transmit (248) the received (245) first signature and verification information set to the participation device 120. For instance, the management device 110 may transmit (248) the first signature and the verification information set to any participation device 120 of the group of participation devices 120. Alternatively, the management device 110 may transmit (248) the first signature and the verification information set to only one or more participation devices of the group of participation devices 120.

The participation device 120 verifies a bidding process of the bidding event 101 based at least on the received (251) first signature and verification information set, and the received (206) encrypted information. For instance, the participation device 120 may verify, using the encrypted information, whether verification information in the first signature that is associated with the participation device 120 conforms to verification information in the verification information set, and whether the verification information conforms to the bid of the participation device 120. If the participation device 120 verifies that nonconforming information exists in the received information, the participation device 120 may transmit indication information indicating that the information is incorrect to the management device 110.

By signing, by the verification device 130, the verification information set determined by the management device 110, it can be ensured that verification information of each participation device 120 cannot be tampered with. In addition, the management device 110 transmits the verification information set including the respective verification information of each participation device 120 to each participation device 120 such that the information provided by the management device 110 to each participation device 120 can be consistent and cannot be tampered with. In this way, cheating behaviors in the online bidding process can be avoided. For instance, collusive cheating between the management device 110 and a participation device 120 can be avoided.

In some embodiments, the management device 110 may further transmit (254) a bid request to the group of participation devices 120. In response to receiving (257) the bid request, participation device 120 may transmit (260) a bid response to the management device 110. For instance, the bid request may be a request for a complete bid of the participation device 120. In this case, the bid response may include a complete bid of the participation device 120 or a coded representation (such as a binary representation or other carry system representations) of the complete bid.

The management device 110 may determine (266) a bidding result 160 of the bidding event 101 based on the received (263) complete bids or coded representations of the complete bids included in bid responses of the group of participation devices 120. The bidding result 160 may indicate a winning device of the group of participation devices 120 and optionally indicate a price required to be given by the winning device. For instance, the management device 110 may determine a participation device 120 having a highest complete bid or a coded representation of the highest complete bid as the winning device. The management device 110 may determine the complete bid of the winning device as the price required to be given by the winning device (that is, the first-price bidding). Alternatively, the management device 110 may further determine a second winning device having a second highest complete bid of the group of participation devices 120. The management device 110 may further determine the complete bid of the second winning device as the price required to be given by the winning device (that is, the second-price bidding).

Additionally or alternatively, in some embodiments, the bid request may be a request for partial bid information of the participation device 120. For instance, the bid request may be a request for at least a part (such as the value at the first position) of the coded representation of the bid of the participation device 120. In this case, the bid response may include the at least the part (such as the value at the first position) of the coded representation of the participation device 120.

In some embodiments, the management device 110 may determine (266) the bidding result 160 by transmitting (254) bid requests for values at position from high to low of the coded representation of the bid of the group of participation devices 120 and based on the received (263) bid responses corresponding to the position. For instance, the management device 110 may request the participation devices 120 for the bidding event 101 to bid bit by bit from high to low until the management device 110 determines (266) the winning device of the bidding event 101.

A determination (266) process of the bidding result 160 based on the bit-by-bit comparison will be described below. In some embodiments, the management device 110 may transmit (254) a first bid request for a first value at a first position of respective coded representation of each of the participation devices for the bidding event 101. The participation devices for the bidding event 101 may be any participation device intending to participate in the bidding event 101, including but not limited to the group of participation devices 120. In response to receiving (257) the first bid request, the participation device 120 may transmit (260) a first bid response to the first bid request to the management device 110. The first response includes a first value of the participation device 120. The management device 110 may receive a corresponding first bid response from at least one participation device 120 of the group of participation devices 120. The first position may be the position of the most significant bit of the coded representation.

Additionally or alternatively, in some embodiments, the first bid response may further include additional verification information. For instance, the first bid response may be generated according to a predefined bit-by-bit bidding process generation function. The first bid response may include coded representation bit[t] of first position t, and optional verification information ver[t] of the position. In some embodiments, verification information ver[t] may be a hash value corresponding to first position t in the hash chain described above.

In some embodiments, the management device 110 may verify the received (263) first bid response. For instance, the management device 110 may verify coded representation bit[t] of first position t (1≤t≤M, where M is a length of the coded representation) by comparing verification information ver[t] of first position t with corresponding information in the received (227) additional verification information.

If the management device 110 determines that coded representation bit[t] of first position t of a certain participation device 120 fails verification (that is, the first bid response is incorrect), or the management device 110 does not receive (263) the first bid response of the certain participation device 120, the management device 110 may remove the participation device from the group of participation devices 120. By removing the participation device 120 that does not bid or incorrectly bids from the group of participation devices 120, a situation that a participation device fails to bid or incorrectly bids in a bit-by-bit bidding process can be handled. In addition, through such anomaly handling, the participation device 120 can be prevented from cheating in a bidding process.

In some embodiments, the management device 110 may determine (266) the bidding result 160 according to comparisons between first values of the group of participation devices 120. For instance, if it is determined that one and only one participation device of the group of participation devices 120 has a first value at a first position that exceeds those of the other participation devices, the management device 110 may determine the bidding result 160 to indicate that the winning device of the bidding event 101 is the participation device. On the contrary, if it is determined that more than one participation devices of the group of participation devices 120 have first values that are not lower than those of the other participation devices, the bidding result 160 may be determined (266) by continuing to compare values of the coded representations of these participation devices 120 at a position lower than the first position.

In some embodiments, the management device 110 may update the group of participation devices 120 by comparing first values of the group of participation devices 120. For instance, a participation device having a first value lower than those of the other participation devices may be removed from the group of participation devices 120. With an example in which the coded representation is a binary representation, a participation device having a first value of 0 may be removed from the group of participation devices 120.

If it is determined that the number of participation devices in the updated group of participation devices 120 exceeds a threshold number (such as 1), the management device 110 may transmit (254), to the updated group of participation devices 120, a second bid request for a second value at a second position of the coded representation. The second position is lower than the first position. For instance, the second position may be the next position of the first position. That is, the second position may be next position t−1 of the first position t. In response to receiving (257) the second bid request, at least one participation device 120 of the updated group of participation devices 120 may transmit (260) a second bid response to the second bid request to the management device 110. The second bid response includes a second value of the coded representation. If the management device 110 does not receive (263) a second bid response of a participation device of the updated group of participation devices 120, the management device 110 may determine the second value of the participation device as 0. In some embodiments, the management device 110 may determine (266) the bidding result 160 based on comparisons between the received second values of the at least one participation device 120.

Similarly, if the management device 110 cannot determine (266) the bidding result 160 according to the second value of the second position, the management device 110 may continue to transmit (254) a bid request for a value of the coded representation at a next lower position, and compare the values. The above bidding process may be continuously carried out bit by bit until the management device 110 determines (266) the winning device. The management device 110 may determine the winning device indicated in the bidding result 160 of the bidding event 101 by using a part of the coded representation of the bid of the participation device 120 through the method of requesting the participation device 120 to bid bit by bit.

In some embodiments, the bidding result 160 may further indicate a price required to be given by the determined winning device. The management device 110 may determine the price based on the received at least a part of the coded representation of each participation device 120.

In some embodiments, the management device 110 may determine the bid of the first participation device of the group of participation devices 120 as the price required to be given by the winning device. The first participation device 120 may be a participation device of the group of participation devices 120 that gives a highest bid, that is, the winning device of the bidding event 101. Such a bidding method of determining a bid of a winning device as the price required to be given by the winning device is also referred to as first-price bidding or first-price auction.

Alternatively, the first participation device 120 may be a second winning device of the group of participation devices 120 that gives a second highest bid. That is, the management device 110 may determine a bid of a second winning device as the price required to be given by the winning device. Such a bidding method of determining a bid of the second winning device as the price to be given by the winning device is also referred to as second-price bidding or second-price auction.

A bidding process of determining a winning device based on a bit-by-bit comparison is described above. In the second-price bidding, the management device 110 needs to determine a second winning device in addition to determining a winning device through the bit-by-bit comparison. The second winning device may be determined through the bit-by-bit comparison similar to bit-by-bit bidding for determining the winning device. For instance, the winning device may be determined first through a method similar to that described above. Then, the second winning device may be determined from the remaining group of participation devices 120 through a similar bit-by-bit comparison method.

Through the bit-by-bit bidding method mentioned above, the winning device (which corresponds to a winner) in the second-price bidding and a price (that is, a bid of the determined second winning device) required to be given by the winning device (which corresponds to the winner) can be determined.

For instance, after determining the winning device and the second winning device, the management device 110 may transmit a bid request for a complete bid to the second winning device. The second winning device transmits a bid response to the management device 110 in response to receiving the bid request. The bid response includes the complete bid of the second winning device. In response to receiving the bid response, the management device 110 may determine the complete bid of the second winning device as the price indicated by the bidding result 160. Alternatively, the bidding result 160 may indicate a coded representation of the price. In this case, the second winning device may transmit a coded representation of the complete bid to the management device 110. The management device 110 may determine the coded representation of the complete bid of the second winning device as the coded representation of the price indicated by the bidding result 160. Additionally, the management device 110 may further transmit the price or the coded representation of the price to the winning device. The management device 110 will take the price from the winning device.

In such a bit-by-bit bidding process, the management device 110 may transmit a bid responses received (263) at each position to the participation device 120 for verification. For instance, the management device 110 may generate a bid response set based on the received (263) bid responses of the group of participation devices 120. The bid response set includes an association relation between the respective bid response of each of the group of participation devices 120 and a corresponding participation device 120. The bid response set may be represented as {bidder_id: bid response at tth position}.

Taking a bid response including only a value (such as a first value) of the coded representation at the position as an example, the management device 110 may generate a first value set based on the respective first value of each of the group of participation devices 120. The first value set includes an association relation between the respective first value of each of the group of participation devices 120 and a corresponding participation device 120.

The management device 110 may transmit the bid response set to the updated group of participation devices 120. For instance, the management device 110 may transmit the first value set to the group of participation devices 120. The participation device 120 may verify the bidding process based on a comparison between the received first value set and the first value of the participation device 120. In addition, the participation device 120 may also verify the bidding process based on the received first value set and additional verification information in the received (251) verification information set. Such a verification process of the participation device 120 is also referred to as online verification or single-step online verification.

By using various bit-by-bit verification processes described above, for instance, by verifying the received first value set by the participation device 120, a situation that the bid information of the participation device 120 is tampered with by the management device 110 can be avoided. In addition, through such single-step bidding and single-step verification, the management device 110 can be prevented from obtaining additional bidding information, thereby ensuring privacy information security of the participation device 120. In this way, cheating behaviors in a bidding process can be avoided, and the bidding process is fairer.

In addition, in an example in which the bidding result 160 is determined through bit-by-bit bidding, the management device 110 requires only a part of the coded representation of the bid of each participation device 120 to determine (266) the bidding result 160. On the one hand, each participation device can be prevented from transmitting complete bid information to the management device 110, thereby avoiding business information leakage. On the other hand, by avoiding information disclosure of the participation device, the participation device will choose to more actively participate in a bidding event rather than forgoing bidding or submitting a false bid to avoid information disclosure.

Several examples in which the management device 110 determines a bidding result 160 are described above. The inventors recognize that cheating may occur in such bit-by-bit bidding processes. For instance, in the first-price bidding process, it is determined that the winning device is a participation device at a 3rd position. After 3rd bidding, the winning device will receive a request from the management device 110 for a complete bid. In this case, the winning device may intend to change a portion having not bided to 0. For instance, the winning device may modify a coded representation of a complete bid to “01001100”, which replaces the original coded representation “01001101” of the bid. In this way, the complete bid changes from 77 to 76. By such a cheating behavior, the fairness of a bidding behavior will be destroyed, earnings of a promoter entrusting the bidding event 101 to the management device 110 will be lost, and further market equilibrium will be destroyed.

For another instance, in the second-price bidding process, the second winning device is determined at a 5th position. After 5th bidding, the second winning device will receive a request from the management device 110 for a complete bid. In this case, the second winning device may intend to change a portion having not bided to 1. For instance, a coded representation of a complete bid is modified to “00111111” to replace the original coded representation “00111001” of a bid. In this way, the complete bid changes from 57 to 63. By such a cheating behavior, the fairness of a bidding behavior will be destroyed, the price to be paid by the winning device will change from 57 to 63, and further market equilibrium will be destroyed. It should be understood that the examples of bids and their coded representations enumerated above are merely exemplary. The scope of the disclosure is not limited in this aspect.

In order to find the above and other cheating behaviors in the bidding process, the management device 110 is further configured to verify the bidding result 160 after determining the bidding result. For instance, the management device 110 may transmit (269) a request for verification information to a first participation device of the group of participation devices 120. The first participation device may be a winning device of the group of participation devices 120 that gives a highest bid and/or a second winning device of the group of participation devices that gives a second highest bid. Herein, the first participation device is also referred to as a key participation device.

In some embodiments, the first participation device transmits (275) a response for verification information to the management device 110 in response to receiving (272) the request for verification information from the management device 110. The response for verification information includes first verification information of the first participation device. The management device 110 verifies the bidding result 160 based on the received (278) first verification information. For instance, in an example in which the first verification information includes a first hash value, the management device 110 may determine a first result hash value based on a price required to be given by the winning device indicated in the bidding result 160. The management device 110 may compare the first hash value included in the first verification information with the determined first result hash value to verify the bidding result 160. Similarly, in an example in which the first verification information includes a second hash value or a third hash value in a hash chain, the management device 110 may further determine a second result hash value or a result hash chain based on a coded representation of a price required to be given by the winning device indicated in the bidding result 160. The management device 110 may further verify the bidding result 160 based on a comparison between the determined second result hash value or a hash value in the result hash chain with a corresponding hash value included in the first verification information.

If the bidding result 160 fails verification, the management device 110 may update a price indicated by the bidding result 160. For instance, in an example of the first-price bidding, the management device 110 may increase a price indicated by the bidding result 160, for instance, set several bits of the coded representation of the price as 1. In an example of the second-price bidding, the management device 110 may reduce the price indicated by the bidding result 160, for instance, set several bits of the coded representation of the price as 0.

In this way, a situation that a winning device of a winner cheats by tampering with a complete bid in first-price bidding can be avoided, and further earnings of a promoter initiating the bidding event 101 can be prevented from losing. In addition, a situation that a second winning device of a second winner cheats by tampering with a complete bid in second-price bidding can also be avoided, such that a situation that benefits of the winner (corresponding to the winning device) lost since the second winner tampers with a complete bid can be avoided.

By handling an anomaly of the bidding result 160 as described above, a cheating behavior of the participation device 120 in the bidding process can be avoided. By using the above anomaly handling process according to the disclosure, every participation device can be prompted to comply with bidding rules or protocols. In this way, a more equalized bidding environment can be formed such that a fairer and more efficient bidding market can be formed.

In some embodiments, the management device 110 may transmit (281) the bidding result 160 to the verification device 130. The verification device (130) may generate (287) a second signature based on the bidding result 160 and using additional encrypted information of the verification device 130. The verification device 130 is further configured to transmit (290) the generated (287) second signature to the management device 110. The management device 110 may transmit (296) the bidding result 160 and the received (293) second signature to one or more participation devices 120 of the group of participation devices 120. For instance, the management device 110 may transmit (296) the bidding result 160 and the received (293) second signature to all the participation devices 120. In some embodiments, the management device 110 may transmit (296) the bidding result 160 and the received (293) second signature only to a key participation device.

By signing the bidding result 160 determined by the management device 110 by the verification device 130, a tamper-proof property of the bidding result 160 transmitted by the management device 110 to the participation device 120 can be ensured, thereby avoiding a cheating behavior.

Additionally or alternatively, the management device 110 may further transmit (296) other additional information verifying the bidding result 160 to the group of participation devices 120. The other additional information may be determined by a bidding mechanism (such as the first-price bidding or the second-price bidding), contents of the verification information (such as the first hash value, the second hash value, the third hash value or the entire hash chain), a degree of privacy protection, etc. For instance, the other additional information may include identity information (such as rnd) of the key participation device or a hash value or some hash values in a hash chain of the key participation device.

After completing the bidding process, the winning device may pay the bid of the winning device, the bid of the second winning device, or a price updated through the above verification process to the promoter of an object (such as a display position) of the bidding event 101, and transmit objects (such as advertisement contents) to be displayed to the promoter.

### Offline Verification With Verification Device

Several embodiments of online bidding are described above in connection with FIG. 2. In some embodiments, after the management device 110 determines (266) the bidding result 160, the participation device 120 may further verify (299) the received bidding result 160. Such verification can be carried out after online bidding, and therefore is also referred to as offline verification.

FIG. 4 shows a schematic diagram of a signaling flow 400 for offline verification of online bidding according to an embodiment of the disclosure. The signaling flow 400 relates to the management device 110, the participation device 120 and the verification device 130 in the environment 100. It should be understood that the signaling flow 400 may relate to any number of management devices 110, any number of participation devices 120 and any number of verification devices 130. It should be understood that the signaling flow 400 may be carried out in combination with the signaling flow 200.

In an operation, the participation device 120 may verify (405) the bidding result 160 based on the received (299) bidding result 160, the second signature, the received (251) verification information set and the received (206) encrypted information. For instance, the participation device 120 may determine the bidding result indicated in the second signature using the encrypted information, and verify whether the received (299) bidding result 160 conforms to the bidding result 160 indicated in the second signature. For instance, in the first-price bidding, the participation device 120 may verify (405) whether the bid of the winning device indicated in the bidding result 160 conforms to the verification information of the winning device. For another instance, in the second-price bidding, the participation device 120 may verify (405) whether the price to be given by the winning device indicated in the bidding result 160 conforms to the verification information of the second winning device.

In addition, the participation device 120 may further verify the bidding result 160 based on the received (299) other additional information. For instance, the participation device 120 may verify (405) the bidding result 160 based on comparing the received (299) identity information (such as md) of the key participation device or a hash value or some hash values in the hash chain of the key participation device with corresponding information of the key participation device in the verification information set.

In some embodiments, the participation device 120 may transmit (410) a verification result obtained through verification (405) to the management device 110. For instance, a group of participation devices 120 may each transmit (410) its verification result to the management device 110.

The management device 110 generates (420) a verification result set based on the received (415) verification results of the group of participation devices 120. For instance, the management device 110 may receive respective identity information (such as bidder_id and/or rnd) of each of the group of participation devices 120. The management device 110 may generate the verification result set based on a respective verification result and identity information of each of the group of participation devices 120. The verification result set includes an association relation between the respective verification result of each of the group of participation devices 120 and identity information of a corresponding participation device 120. For instance, mapping of identity information bidder_id and a verification result may be generated as a verification result set by using an information packaging program based on respective identity information bidder_id and a respective verification result of each of the group of participation devices 120.

The management device 110 is configured to transmit (425) the generated (420) verification result set to the verification device 130. The verification device 130 generates (435) a third signature using additional encrypted information associated with encrypted information based on the received (430) verification result set. For instance, the encrypted information may be a public key of the verification device 130, and the additional encrypted information may be a private key of the verification device 130.

Additionally or alternatively, the verification device 130 may further determine (440) a verification conclusion based on each of the verification results included in the received (430) verification result set. For instance, if no verification result that indicates that the bidding result 160 is wrong exists in the verification result set received (430) by the verification device 130, the verification device 130 may determine that the verification conclusion is that no anomaly exists in the bidding process, that is, the bidding result 160 is correct. On the contrary, if a verification result that indicates that the bidding result 160 is wrong exists in the verification result set received (430) by the verification device 130, the verification device 130 may determine that the verification conclusion indicates that an anomaly exists in the bidding process, that is, the bidding result 160 is incorrect.

The verification device 130 transmits (445) the generated (435) third signature and the determined (440) verification conclusion to the management device 110. The management device 110 may transmit (455) the received (450) third signature and verification conclusion to the group of participation devices 120. For instance, the management device 110 may transmit (455) the third signature and verification conclusion to any participation device 120 of the group of participation devices 120. Alternatively, the management device 110 may transmit (455) the third signature and verification conclusion only to one or more participation devices of the group of participation devices 120, such as a key participation device. The participation device 120 receives (460) the third signature and the verification conclusion, so as to know whether the bidding result 160 of the bidding event 101 is correct.

By verifying the bidding result 160 by the participation device 120, the correctness of the price required to be given by the winning device can be ensured. In this way, cheating behaviors in a bidding process can be avoided, and the bidding process is fairer.

By using various online verification and offline verification processes according to the disclosure, on the one hand, the participation device 120 can verify the bidding process, such as the correctness and privacy control of the bit-by-bit bidding process. On the other hand, the verification device 130 can verify the identity of the winner and the correctness of the price required to be given by the winner. In this way, various collusive cheating behaviors of the management device 110 with any participation device 120 or of the management device 110 with the verification device 130 will not pass verification. According to the solution of the disclosure, the bidding event can be ensured to be safely carried out, and the correctness of the bidding result can be verified.

### Example Process

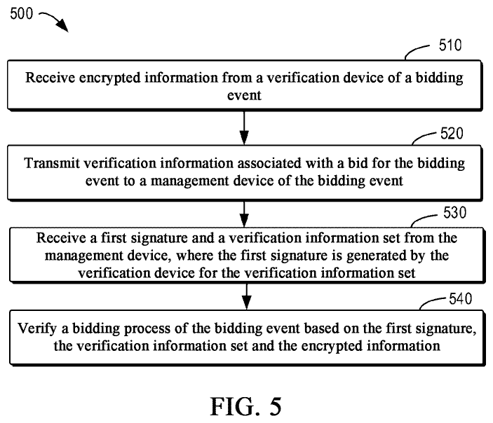

FIG. 5 shows a flow diagram 500 of an example process for online bidding according to an embodiment of the disclosure. The process 500 may be implemented at the participation device 120. It should be understood that the process 500 may also be executed by other suitable devices or apparatuses. The process 500 may include additional actions not shown and/or shown actions may be omitted. The scope of the disclosure is not limited in this respect.

At block 510, the participation device 120 receives encrypted information from the verification device 130 of the bidding event 101. For instance, the encrypted information may be a public key of the verification device 130.

At block 520, the participation device 120 transmits verification information associated with the bid for the bidding event 101 to the management device 110 of the bidding event 101. In some embodiments, the participation device 120 is further configured to receive identity information of the bidding event 101 from the management device 110. The participation device 120 generates the verification information based at least on the identity information and the bid of the bidding event 101. In some embodiments, in order to generate the verification information, the participation device 120 may be configured to generate a first hash value based on the identity information of the bidding event 101, identity information of the participation device 120, and the bid. The participation device 120 further generates the verification information based on the first hash value.

Additionally or alternatively, in some embodiments, in order to generate verification information, the participation device 120 is configured to generate a second hash value based on the identity information of the bidding event 101, the identity information of the participation device 120, and a coded representation of the bid. The participation device 120 further generates the verification information based on the second hash value.

Additionally or alternatively, in some embodiments, in order to generate verification information, the participation device 120 is configured to generate a hash chain associated with the coded representation based on the identity information of the bidding event 101, the identity information of the participation device 120, and the coded representation of the bid. The hash chain includes a group of hash values corresponding to positions of the coded representation and a third hash value other than the group of hash values. The participation device 120 further generates the verification information based on the third hash value.

At block 530, the participation device 120 receives a first signature and a verification information set from the management device 110. The verification information set includes at least an association relation between the participation device 120 and the verification information. The first signature is generated by the verification device 130 for the verification information set.

At block 540, the participation device 120 verifies a bidding process of the bidding event 101 based on the first signature, the verification information set and the encrypted information.

In some embodiments, the participation device 120 is further configured to transmit the bid for the bidding event 101 or at least a part of a coded representation of the bid to the management device 110. The participation device 120 is further configured to receive the bidding result 160 and the second signature from the management device 110. The bidding result 160 is determined based at least on a respective bid of each of a group of participation devices including the participation device 120 or at least a part of a coded representation of the bid. The bidding result 160 indicates the winning device of the bidding event 101 and the price required to be given by the winning device. The second signature is generated by the verification device 130 for the bidding result 160.

In some embodiments, in order to verify the bidding process, the participation device 120 may verify the bidding result 160 of the bidding process based on the bidding result 160, the second signature, the verification information set and the encrypted information.

In some embodiments, the participation device 120 may transmit the verification result obtained by verifying the bidding result 160 to the management device 110. The verification result indicates whether the bidding result 160 is correct. Alternatively or additionally, the participation device 120 may further receive a third signature and a verification result set from the management device 110. The verification result set includes at least an association relation between the verification result and the participation device 120. This third signature is generated by the verification device 130 based on the verification result set.

In some embodiments, the at least a part of the coded representation of the bid of the participation device 120 includes a first value at a first position of the coded representation. In this case, in order to verify the bidding process, the participation device 120 may receive a first value set from the management device 110. The first value set includes at least an association relation between the first value of the participation device 120 and the participation device 120. The participation device 120 may verify the bidding process based on the first value set and the first value of the participation device 120.

In some embodiments, the participation device 120 is further configured to transmit, in response to receiving a request for the verification information of the participation device 120 from the management device 110, a response to the request to the management device 110. The response includes the verification information of the participation device 120.

In some embodiments, the participation device 120 is further configured to transmit the identity information of the participation device 120 to the management device 110.

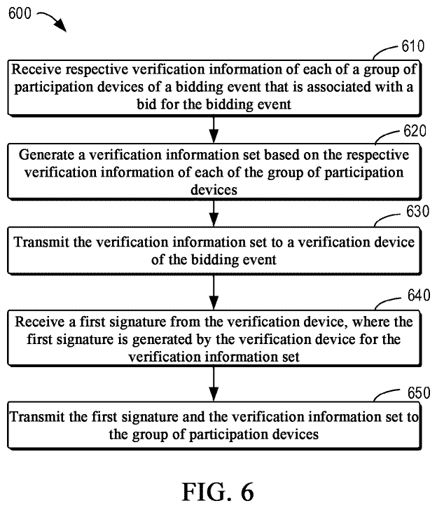

FIG. 6 shows a flow diagram 600 of an example process configured to execute bidding according to an embodiment of the disclosure. The process 600 may be implemented at the management device 110. It should be understood that the process 600 may also be executed by other suitable devices or apparatuses. The process 600 may include additional actions not shown and/or shown actions may be omitted. The scope of the disclosure is not limited in this respect.

At block 610, the management device 110 receives respective verification information of each of a group of participation devices 120 of a bidding event 101 that is associated with a bid for the bidding event 101. At block 620, the management device 110 generates a verification information set based on the respective verification information of each of the group of participation devices 120. The verification information set includes an association relation between the respective verification information of each of the group of participation devices 120 and a corresponding participation device 120. In some embodiments, in order to generate the verification information set, the management device 110 may receive respective identity information of each of the group of participation devices 120. The management device 110 may further generate the verification information set based on the respective verification information and the respective identity information of each of the group of participation devices 120. The verification information set includes an association relation between the verification information and the identity information of the group of participation devices 120.

At block 630, the management device 110 transmits the verification information set to the verification device 130 of the bidding event 101. At block 640, the management device 110 receives a first signature from the verification device 130. The first signature is generated by the verification device 130 for the verification information set. At block 650, the management device 110 transmits the first signature and the verification information set to the group of participation devices 120.

In some embodiments, the management device 110 is further configured to receive the respective bid for the bidding event 101 of each of the group of participation devices 120 or at least a part of a coded representation of the bid. The management device 110 is further configured to determine the bidding result 160 of the bidding event 101 based at least on the respective bid of each of the group of participation devices 120 or the at least a part of the coded representation of the bid. The bidding result 160 indicates the winning device in the group of participation devices 120 and the price required to be given by the winning device. The management device 110 is further configured to transmit the bidding result 160 to the verification device 130. The management device 110 is further configured to receive the second signature from the verification device 130. The second signature is generated by the verification device 130 for the bidding result 160. The management device 110 is further configured to transmit the second signature and the bidding result 160 to the group of participation devices 120.

In some embodiments, in order to determine the bidding result 160 based on at least a part of the coded representation of the respective bid of each of the group of participation devices 120, the management device 110 may determine the bidding result 160 based on at least comparisons of first values at first positions of respective coded representations of the group of participation devices 120.

In some embodiments, the management device 110 is further configured to generate a first value set based on the respective first value of each of the group of participation devices 120. The first value set includes an association relation between the respective first value of each of the group of participation devices 120 and a corresponding participation device 120. The management device 110 transmits the first value set to the group of participation devices 120.

In some embodiments, the management device 110 is further configured to transmit a request for first verification information of a first participation device to the first participation device of the group of participation devices 120. The management device 110 may receive a response from the first participation device. The response includes first verification information. The management device 110 may update the bidding result 160 based on the first verification information. In such embodiments, in order to transmit the bidding result 160 to the verification device 130, the management device 110 may transmit the updated bidding result 160 to the verification device 130. In some embodiments, the first participation device may be the winning device in the group of participation devices 120 that gives the highest bid. Alternatively, in some embodiments, the first participation device may be a second winning device of the group of participation devices 120 that gives a second highest bid.

In some embodiments, the management device 110 is further configured to receive a respective verification result of each of the group of participation devices 120 that indicates whether the bidding result 160 of the bidding event 101 is correct. The management device 110 may generate the verification result set based on a respective verification result of each of the group of participation devices 120. The verification result set includes an association relation between the respective verification result of each of the group of participation devices 120 and a corresponding participation device 120. The management device 110 may transmit the verification result set to the verification device 130. The management device 110 may further receive a third signature from the verification device 130. This third signature is generated by the verification device 130 based on the verification result set. The management device 110 may further transmit the third signature and the verification result set to the group of participation devices 120.

In some embodiments, the management device 110 is further configured to receive identity information of the bidding event 101 from the verification device 130. The management device 110 is further configured to transmit identity information of the bidding event 101 to the group of participation devices 120.

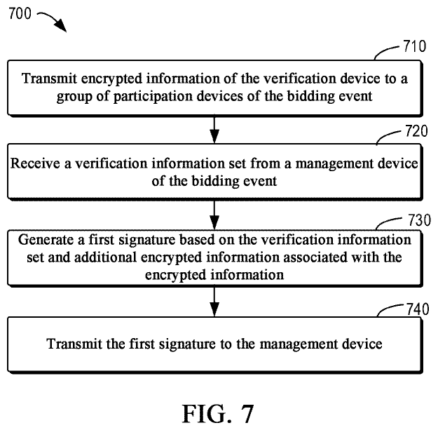

FIG. 7 shows a flow diagram 700 of an example process configured to participate in bidding according to an embodiment of the disclosure. The process 700 may be implemented at the verification device 130. It should be understood that the process 700 may also be executed by other suitable devices or apparatuses. The process 700 may include additional actions not shown and/or shown actions may be omitted. The scope of the disclosure is not limited in this respect.

At block 710, the verification device 130 transmits encrypted information of the verification device 130 to a group of participation devices 120 of the bidding event 101. For instance, the encrypted information may be a public key of the verification device 130.

At block 720, the verification device 130 receives a verification information set from a management device 110 of the bidding event 101. The verification information set includes an association relation between the respective verification information of each of the group of participation devices 120 and a corresponding participation device 120. At block 730, the verification device 130 generates a first signature based on the verification information set and using additional encrypted information associated with the encrypted information. For instance, the additional encrypted information may be a private key of the verification device 130. At block 740, the verification device 130 transmits the first signature to the management device 110.

In some embodiments, the verification device 130 may receive the bidding result 160 of the bidding event 101 from the management device 110. The bidding result 160 indicates the winning device in the group of participation devices 120 and the price required to be given by the winning device. The verification device 130 may generate a second signature based on the bidding result 130 and using the additional encrypted information. The verification device 130 may transmit the second signature to the management device 110.

Additionally or alternatively, in some embodiments, the verification device 130 may receive the verification result set from the management device 110. The verification result set includes a respective verification result of each of the group of participation devices 120 that indicates whether the bidding result of the bidding event 101 is correct. The verification device 130 may determine a verification conclusion based on the verification result set. The verification conclusion indicates whether an anomaly exists in the bidding process of the bidding event 101. The verification device 130 may generate a third signature based on the verification conclusion and using additional encrypted information. In addition, the verification device 130 may further transmit the third signature to the management device 110.

In some embodiments, the verification device 130 may further transmit identity information of the bidding event 101 to the management device 110.

### Example Apparatus and Device

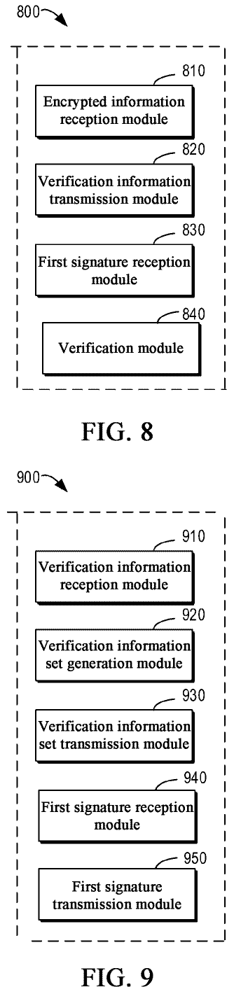

FIG. 8 shows a schematic structural block diagram of an apparatus 800 for online bidding according to some embodiments of the disclosure. The apparatus 800 may be implemented as or included at the participation device 120. Various modules/components in the apparatus 800 may be implemented by hardware, software, firmware, or any combination thereof.

As shown in the figure, the apparatus 800 includes an encrypted information reception module 810 configured to receive encrypted information from the verification device 130 of the bidding event 101. For instance, the encrypted information may be a public key of the verification device 130.

The apparatus 800 further includes a verification information transmission module 820 configured to transmit verification information associated with a bid for the bidding event 101 to a management device 110 of the bidding event 101. In some embodiments, the apparatus 800 further includes an identity information reception module configured to receive identity information of the bidding event 101 from the management device 110. The apparatus 800 further includes a verification information generation module configured to generate verification information based at least on the identity information and the bid of the bidding event 101. In some embodiments, the verification information generation module includes a first hash value generation module configured to generate a first hash value based on identity information of the bidding event 101, identity information of the apparatus 800, and the bid. The verification information generation module further includes a first generation module configured to generate verification information based on the first hash value.

Additionally or alternatively, in some embodiments, the verification information generation module further includes a second hash value generation module configured to generate a second hash value based on the identity information of the bidding event 101, the identity information of the apparatus 800, and a coded representation of the bid. The verification information generation module further includes a second generation module configured to generate verification information based on the second hash value.

Additionally or alternatively, in some embodiments, the verification information generation module includes a third hash value generation module configured to generate a hash chain associated with the coded representation based on the identity information of the bidding event 101, the identity information of the apparatus 800, and the coded representation of the bid. The hash chain includes a group of hash values corresponding to positions of the coded representation and a third hash value other than the group of hash values. The verification information generation module further includes a third generation module configured to generate verification information based on the third hash value.

The apparatus 800 further includes a first signature reception module 830 configured to receive a first signature and a verification information set from the management device 110. The verification information set includes at least an association relation between the apparatus 800 and the verification information. The first signature is generated by the verification device 130 for the verification information set.

The apparatus 800 further includes a verification module 840 configured to verify a bidding process of the bidding event 101 based on the first signature, the verification information set and the encrypted information.

In some embodiments, the apparatus 800 further includes a bid transmission module configured to transmit the bid for the bidding event 101 or at least a part of the coded representation of the bid to the management device 110. The apparatus 800 further includes a second signature reception module configured to receive the bidding result 160 and the second signature from the management device 110. The bidding result 160 is determined based at least on a respective bid of each of a group of apparatuses including the apparatus 800 or at least a part of a coded representation of the bid. The bidding result 160 indicates the winning apparatus of the bidding event 101 and the price required to be given by the winning apparatus. This second signature is generated by the verification device 130 for the bidding result 160.

In some embodiments, the verification module 840 includes a bidding result verification module configured to verify the bidding result 160 of the bidding process based on the bidding result 160, the second signature, the verification information set and the encrypted information.

In some embodiments, the apparatus 800 further includes a verification result transmission module configured to transmit the verification result obtained by verifying the bidding result 160 to the management device 110. The verification result indicates whether the bidding result 160 is correct.

Alternatively or additionally, the apparatus 800 further includes a third signature reception module configured to receive a third signature and a verification result set from the management device 110. The verification result set includes at least an association relation between the verification result and the apparatus 800. This third signature is generated by the verification device 130 based on the verification result set.

In some embodiments, the at least a part of the coded representation of the bid of the apparatus 800 includes a first value at a first position of the coded representation. In such embodiments, the verification module 840 includes a first value set reception module configured to receive the first value set from the management device 110. The first value set includes at least an association relation between a first value of the apparatus 800 and the apparatus 800. The verification module 840 further includes a bidding process verification module configured to verify the bidding process based on the first value set and the first value of the apparatus 800.

In some embodiments, the apparatus 800 further includes a response transmission module configured to transmit, in response to receiving a request for the verification information of the apparatus 800 from the management device 110, a response to the request to the management device 110. The response includes the verification information of the apparatus 800.

In some embodiments, the apparatus 800 further includes an identity information transmission module configured to transmit the identity information of the apparatus 800 to the management device 110.

FIG. 9 shows a schematic structural block diagram of an apparatus 900 for online bidding according to some embodiments of the disclosure. The apparatus 900 may be implemented as or included at the management device 110. Various modules/components in the apparatus 900 may be implemented by hardware, software, firmware or any combination thereof.

As shown in the figures, the apparatus 900 includes a verification information reception module 910 configured to receive respective verification information of each of a group of participation devices 120 of a bidding event 101 that is associated with a bid for the bidding event 101. The apparatus 900 further includes a verification information set generation module 920 configured to generate a verification information set based on the respective verification information of each of the group of participation devices 120. The verification information set includes an association relation between the respective verification information of each of the group of participation devices 120 and a corresponding participation device 120. In some embodiments, the verification information set generation module 920 includes an identity information reception module configured to receive respective identity information of each of the group of participation devices 120. The verification information set generation module 920 further includes a second generation module configured to generate a verification information set based on the respective verification information and the respective identity information of each of the group of participation devices 120. The verification information set includes an association relation between the verification information and the identity information of the group of participation devices 120.

The apparatus 900 further includes a verification information set transmission module 930 configured to transmit the verification information set to the verification device 130 of the bidding event 101. The apparatus 900 further includes a first signature reception module 940 configured to receive a first signature from the verification device 130. The first signature is generated by the verification device 130 for the verification information set. The apparatus 900 further includes a first signature transmission module 950 configured to transmit the first signature and the verification information set to the group of participation devices 120.

In some embodiments, the apparatus 900 further includes a bid reception module configured to receive the respective bid for the bidding event 101 of each of the group of participation devices 120 or at least a part of a coded representation of the bid. The apparatus 900 further includes a bidding result determination module configured to determine the bidding result 160 of the bidding event 101 based at least on the respective bid of each of the group of participation devices 120 or the at least a part of the coded representation of the bid. The bidding result 160 indicates the winning device in the group of participation devices 120 and the price required to be given by the winning device. The apparatus 900 further includes a bidding result transmission module configured to transmit the bidding result 160 to the verification device 130. The apparatus 900 further includes a second signature reception module configured to receive a second signature from the verification device 130. The second signature is generated by the verification device 130 for the bidding result 160. The apparatus 900 further includes a second signature transmission module configured to transmit the second signature and the bidding result 160 to the group of participation devices 120.

In some embodiments, the bidding result determination module includes a first value comparison module configured to determine the bidding result 160 based on at least comparisons of first values at the first positions of respective coded representations of the group of participation devices 120.

In some embodiments, the apparatus 900 further includes a first value set generation module configured to generate a first value set based on the first values of the group of participation devices 120. The first value set includes an association relation between the respective first value of each of the group of participation devices 120 and a corresponding participation device 120. The apparatus 900 further includes a first value set transmission module configured to transmit the first value set to the group of participation devices 120.

In some embodiments, the apparatus 900 further includes a request transmission module configured to transmit, to a first participation device of the group of participation devices 120, a request for first verification information of the first participation device. The apparatus 900 further includes a response reception module configured to receive a response from the first participation device. The response includes first verification information. The apparatus 900 further includes a bidding result update module configured to update the bidding result 160 based on the first verification information. In such embodiments, the bidding result transmission module further includes an update result transmission module configured to transmit the updated bidding result 160 to the verification device 130. In some embodiments, the first participation device may be the winning device in the group of participation devices 120 that gives the highest bid. Alternatively, in some embodiments, the first participation device may be a second winning device of the group of participation devices 120 that gives a second highest bid.

In some embodiments, the apparatus 900 further includes a verification result reception module configured to receive a respective verification result of each of the group of participation devices 120 that indicates whether the bidding result 160 of the bidding event 101 is correct. The apparatus 900 further includes a verification result set generation module configured to generate a verification result set based on the respective verification result of each of the group of participation devices 120. The verification result set includes an association relation between a respective verification result of each of the group of participation devices 120 and a corresponding participation device 120. The apparatus 900 further includes a verification result set transmission module configured to transmit the verification result set to the verification device 130. The apparatus 900 further includes a third signature reception module configured to receive a third signature from the verification device 130. This third signature is generated by the verification device 130 based on the verification result set. The apparatus 900 further includes a third signature transmission module configured to transmit the third signature and the verification result set to the group of participation devices 120.

In some embodiments, the apparatus 900 further includes an identity information reception module configured to receive identity information of the bidding event 101 from the verification device 130. The apparatus 900 further includes an identity information transmission module configured to transmit identity information of the bidding event 101 to the group of participation devices 120.

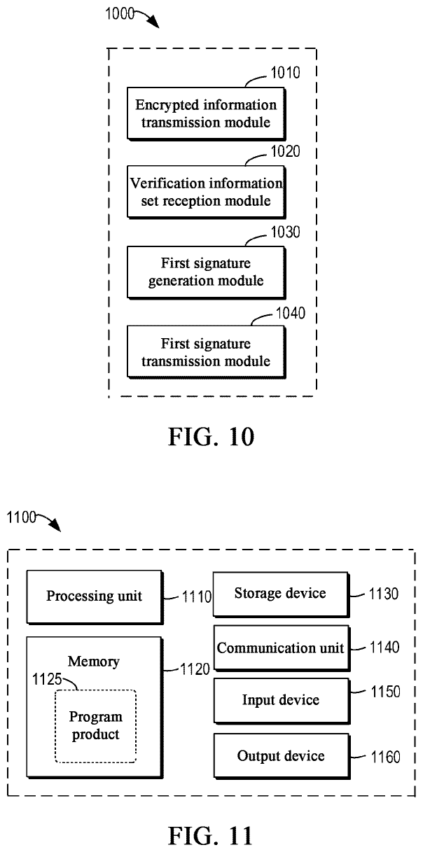

FIG. 10 shows a schematic structural block diagram of an apparatus 1000 for online bidding according to some embodiments of the disclosure. The apparatus 1000 may be implemented as or included at the verification device 130. Various modules/components in the apparatus 1000 may be implemented by hardware, software, firmware or any combination thereof.

As shown in the figure, the apparatus 1000 includes an encrypted information transmission module 1010 configured to transmit encrypted information of the verification device 130 to a group of participation devices 120 of the bidding event 101. For instance, the encrypted information may be a public key of the apparatus 1000.

The apparatus 1000 further includes a verification information set reception module 1020 configured to receive a verification information set from the management device 110 of the bidding event 101. The verification information set includes an association relation between respective verification information of each of the group of participation devices 120 and a corresponding participation device 120. The apparatus 1000 further includes a first signature generation module 1030 configured to generate a first signature based on the verification information set and using additional encrypted information associated with the encrypted information. For instance, the additional encrypted information may be a private key of the apparatus 1000. The apparatus 1000 further includes a first signature transmission module 1040 configured to transmit the first signature to the management device 110.

In some embodiments, the apparatus 1010 further includes a bidding result reception module configured to receive the bidding result 160 of the bidding event 101 from the management device 110. The bidding result 160 indicates the winning device in the group of participation devices 120 and the price required to be given by the winning device. The apparatus 1010 further includes a second signature generation module configured to generate a second signature based on the bidding result 130 using the additional encrypted information. The apparatus 1000 further includes a second signature transmission module configured to transmit the second signature to the management device 110.

Additionally or alternatively, in some embodiments, the apparatus 1000 further includes a verification result set reception module configured to receive the verification result set from the management device 110. The verification result set includes a respective verification result of each of the group of participation devices 120 that indicates whether the bidding result of the bidding event 101 is correct. The apparatus 1000 further includes a verification conclusion determination module configured to determine a verification conclusion based on the verification result set. The verification conclusion indicates whether an anomaly exists in the bidding process of the bidding event 101. The apparatus 1000 further includes a third signature generation module configured to generate a third signature based on the verification conclusion using the additional encrypted information. In addition, the apparatus 1000 further includes a third signature transmission module configured to transmit the third signature to the management device 110.

In some embodiments, the apparatus 1000 further includes an identity information transmission module configured to transmit identity information of the bidding event 101 to the management device 110.

FIG. 11 shows a block diagram of a computing device 1100 in which one or more embodiments of the disclosure can be implemented. It should be understood that the computing device 1100 shown in FIG. 11 is merely exemplary and should not be construed as any limitation on the functions or scopes of the embodiments described herein. The computing device 1100 shown in FIG. 11 may be configured to implement the management device 110 and/or the participation device 120 and/or the verification device 130 in FIG. 1.

As shown in FIG. 11, the computing device 1100 is in the form of a general purpose computing device. Components of the computing device 1100 may include but are not limited to one or more processors or processing units 1110, a memory 1120, a storage device 1130, one or more communication units 1140, one or more input devices 1150, and one or more output devices 1160. The processing unit 1110 may be a real or virtual processor and can execute various processes according to programs stored in the memory 1120. In a multi-processor system, a plurality of processing units execute computer-executable instructions in parallel to increase parallel processing capabilities of the computing device 1100.

The computing device 1100 generally includes a plurality of computer storage media. Such media may be any available media that are accessible by the computing device 1100, and include but not limited to volatile and nonvolatile media, and removable and non-removable media. The memory 1120 may be a volatile memory (such as a register, a cache, a random access memory (RAM)), a nonvolatile memory (such as a read-only memory (ROM), an electrically erasable programmable read-only memory (EEPROM), and a flash memory), or their combinations. The storage device 1130 may be a removable or non-removable medium and may include a machine-readable medium such as a flash drive, a magnetic disk, or any other media that can be configured to store information and/or data (such as training data for training) and that can be accessed within the computing device 1100.

The computing device 1100 may further include additional removable/non-removable, and volatile/nonvolatile storage media. Although not shown in FIG. 11, magnetic disk drives for reading from or writing to removable and nonvolatile magnetic disks (such as “floppy disks”) and optical disk drives for reading from or writing to removable and nonvolatile optical disks may be provided. In these cases, each drive may be connected to a bus (not shown) by means of one or more data medium interface. The memory 1120 may include a computer program product 1125 having one or more program modules. These program modules are configured to execute various methods or actions in various embodiments of the disclosure.

The communication unit 1140 is in communication with other computing devices by means of a communication medium. Additionally, the functions of the components of the computing device 1100 may be implemented in a single computing cluster or a plurality of computing machines. These computing machines can be in communication through communication connections. Thus, the computing device 1100 may operate in a networked environment by using logical connections to one or more other servers, a network personal computer (PC), or another network node.

The input device 1150 may be one or more input devices, such as a mouse, a keyboard and a trackball. The output device 1160 may be one or more output devices, such as a display, a speaker and a printer. The computing device 1100 may be in communication, by means of the communication unit 1140 according to requirements, with one or more external devices (not shown) such as a storage device and a display device, one or more devices that enable a user to interact with the computing device 1100, or any device (such as a network card and a modem) that enables the computing device 1100 to be in communication with one or more other computing devices. Such communication may be executed through an input/output (I/O) interface (not shown).

According to example embodiments of the disclosure, a computer-readable storage medium is provided. The computer-readable storage medium stores a computer-executable instruction. The computer-executable instruction is executed by a processor to implement the method described above. According to example implementations of the disclosure, a computer program product is further provided. The computer program product is tangibly stored on a non-transitory computer-readable medium and includes a computer-executable instruction. The computer-executable instruction is executed by a processor to implement the methods described above.

Various aspects of the disclosure are described herein with reference to flow diagrams and/or block diagrams of the method, apparatus, device, and computer program product implemented according to the disclosure. It should be understood that each block of the flow diagram and/or the block diagram and combinations of blocks in the flow diagram and/or the block diagram can be implemented by a computer-readable program instruction.

These computer-readable program instructions may be provided to a processing unit of a general purpose computer, a special purpose computer, or other programmable data processing apparatuses to produce a machine, such that these instructions generate an apparatus for implementing specified functions/actions in one or more blocks of the flow diagram and/or the block diagram when executed by the processing unit of the computer or other programmable data processing apparatuses. These computer-readable program instructions may also be stored in a computer-readable storage medium. These instructions cause a computer, a programmable data processing apparatus, and/or other devices to work in a particular manner. Thus, the computer-readable medium storing an instruction includes an article of manufacture including instructions for implementing various aspects of specified functions/actions in one or more blocks of the flow diagram and/or the block diagram

The computer-readable program instructions may be loaded onto a computer, other programmable data processing apparatuses, or other devices, such that a series of operational steps are executed on the computer, other programmable data processing apparatuses, or other devices to produce a computer implemented process. Further, the instructions executed on the computer, other programmable data processing apparatuses, or other devices implement the specified functions/actions in one or more blocks of the flow diagram and/or the block diagram.

Flow diagrams and block diagrams in figures show system architectures, functions and operations, which may be implemented according to a plurality of systems, methods and computer program products of the disclosure. In this regard, each block in flow diagrams or block diagrams can represent a module, a program segment, or a part of an instruction, which include one or more executable instructions configured to implement specified logical functions. In some substitutive implementations, functions noted in blocks can also occur in sequences different from those in figures. For instance, functions represented by two continuous blocks can be executed substantially in parallel in practice, and sometimes implemented in reverse sequences, which depends on the involved functions. It should also be noted that each block in flow diagrams and/or block diagrams, and combinations of the blocks in the flow diagrams and/or the block diagrams, can be implemented by means of dedicated hardware-based systems that execute specified functions or actions, or can be implemented by means of combinations of dedicated hardware and computer instructions.

Various implementations of the disclosure are described above. The above descriptions are exemplary, not exhaustive and not limited to the disclosed various implementations. Many modifications and variations will be apparent to those of ordinary skill in the art without departing from the scopes and spirits of the described various implementations. The terms used herein are chosen to best explain the principles and practical application of various implementations or technical improvement in the market, or enable others of ordinary skill in the art to understand various implementations disclosed herein.

I/we claim:

1. A method for online bidding, comprising:
receiving, at a participation device of a bidding event, encrypted information from a verification device of the bidding event;
transmitting verification information associated with a bid of the bidding event to a management device of the bidding event;
receiving a first signature and a verification information set from the management device, wherein the verification information set comprises at least an association relation between the participation device and the verification information, and the first signature is generated by the verification device for the verification information set; and
verifying a bidding process of the bidding event based on the first signature, the verification information set and the encrypted information.

2. The method according to claim 1, further comprising:
receiving identity information of the bidding event from the management device; and
generating the verification information based at least on the identity information of the bidding event and the bid.

3. The method according to claim 2, wherein generating the verification information comprises:
generating a first hash value based on the identity information of the bidding event, identity information of the participation device, and the bid; and
generating the verification information based on the first hash value.

4. The method according to claim 2, wherein generating the verification information comprises:
generating a second hash value based on the identity information of the bidding event, identity information of the participation device, and a coded representation of the bid; and
generating the verification information based on the second hash value.

5. The method according to claim 2, wherein generating the verification information comprises:
generating, based on the identity information of the bidding event, identity information of the participation device, and a coded representation of the bid, a hash chain associated with the coded representation, wherein the hash chain comprises a group of hash values corresponding to positions of the coded representation and a third hash value other than the group of hash values; and
generating the verification information based on the third hash value.

6. The method according to claim 1, further comprising:
transmitting the bid for the bidding event or at least a part of a coded representation of the bid to the management device; and
receiving a bidding result and a second signature from the management device, wherein the bidding result is determined based at least on a respective bid of each of a group of participation devices comprising the participation device or at least a part of a coded representation of the respective bid, the bidding result indicates a winning device of the bidding event and a price required to be given by the winning device, and the second signature is generated by the verification device for the bidding result.

7. The method according to claim 6, wherein verifying the bidding process comprises:
verifying the bidding result of the bidding process based on the bidding result, the second signature, the verification information set, and the encrypted information; and
the method further comprising:
transmitting a verification result obtained by verifying the bidding result to the management device, wherein the verification result indicates whether the bidding result is correct; and
receiving a third signature and a verification result set from the management device, wherein the verification result set comprises at least an association relation between the verification result and the participation device, and the third signature is generated by the verification device based on the verification result set.

8. The method according to claim 6, wherein the at least a part of the coded representation of the bid comprises a first value at a first position of the coded representation; and wherein
verifying the bidding process comprises:
receiving a first value set from the management device, wherein the first value set comprises at least an association relation between the first value of the participation device and the participation device; and
verifying the bidding process based on the first value set and the first value of the participation device.

9. The method according to claim 1, further comprising:
transmitting, in response to receiving a request for the verification information of the participation device from the management device, a response to the request to the management device, wherein the response comprises the verification information; and
transmitting identity information of the participation device to the management device.

10. A method for online bidding, comprising:
receiving, at a management device of a bidding event, verification information of each of a group of participation devices of the bidding event that is associated with a bid of the bidding event;
generating a verification information set based on the verification information of each of the group of participation devices, wherein the verification information set comprises an association relation between the verification information of each of the group of participation devices and a corresponding participation device;
transmitting the verification information set to a verification device of the bidding event;
receiving a first signature from the verification device, wherein the first signature is generated by the verification device for the verification information set; and
transmitting the first signature and the verification information set to the group of participation devices.

11. The method according to claim 10, further comprising:
receiving a respective bid of each of the group of participation devices for the bidding event or at least a part of a coded representation of the respective bid;
determining a bidding result of the bidding event based at least on the respective bid of each of the group of participation devices or the at least a part of the coded representation of the respective bid, wherein the bidding result indicates a winning device in the group of participation devices and a price required to be given by the winning device;
transmitting the bidding result to the verification device;
receiving a second signature from the verification device, wherein the second signature is generated by the verification device for the bidding result; and
transmitting the second signature and the bidding result to the group of participation devices.

12. The method according to claim 11, wherein determining the bidding result based on the at least a part of the coded representation of the respective bid of each of the group of participation devices comprises:
determining the bidding result based at least on comparisons of first values at first positions of the coded representation of each of the group of participation devices; and
the method further comprising:
generating a first value set based on the first value of each of the group of participation devices, wherein the first value set comprises an association relation between the first value of each of the group of participation devices and a corresponding participation device; and
transmitting the first value set to the group of participation devices.

13. The method according to claim 11, further comprising:
transmitting, to a first participation device in the group of participation devices, a request for first verification information of the first participation device;
receiving a response from the first participation device, wherein the response comprises the first verification information; and
updating the bidding result based on the first verification information; and
wherein transmitting the bidding result to the verification device comprises transmitting the updated bidding result to the verification device.

14. The method according to claim 13, wherein the first participation device is at least one of:
the winning device in the group of participation devices that gives a highest bid; or
a second winning device in the group of participation devices that gives a second highest bid.

15. The method according to claim 10, further comprising:
receiving a verification result of each of the group of participation devices that indicates whether a bidding result of the bidding event is correct;
generating a verification result set based on the verification result of each of the group of participation devices, wherein the verification result set comprises an association relation between the verification result of each of the group of participation devices and a corresponding participation device;
transmitting the verification result set to the verification device;
receiving a third signature from the verification device, wherein the third signature is generated by the verification device based on the verification result set; and
transmitting the third signature and the verification result set to the group of participation devices.

16. The method according to claim 10, wherein generating the verification information set comprises:
receiving identity information of each of the group of participation devices; and
generating the verification information set based on the verification information and the identity information of each of the group of participation devices, wherein the verification information set comprises an association relation between the verification information and the identity information of each of the group of participation devices.

17. The method according to claim 10, further comprising:
receiving identity information of the bidding event from the verification device; and
transmitting the identity information of the bidding event to the group of participation devices.

18. A method for online bidding, comprising:
transmitting, at a verification device of a bidding event, encrypted information of the verification device to a group of participation devices of the bidding event;
receiving a verification information set from a management device of the bidding event, wherein the verification information set comprises an association relation between verification information of each of the group of participation devices and a corresponding participation device;
generating a first signature based on the verification information set and by using additional encrypted information associated with the encrypted information; and
transmitting the first signature to the management device.

19. The method according to claim 18, wherein the encrypted information is a public key of the verification device, and the additional encrypted information is a private key of the verification device.

20. The method according to claim 18, further comprising:
receiving a bidding result of the bidding event from the management device, wherein the bidding result indicates a winning device in the group of participation devices and a price required to be given by the winning device;
generating a second signature based on the bidding result and using the additional encrypted information;
transmitting the second signature to the management device;
receiving a verification result set from the management device, wherein the verification result set comprises a verification result of each of the group of participation devices that indicates whether a bidding result of the bidding event is correct;
determining a verification conclusion based on the verification result set, wherein the verification conclusion indicates whether an anomaly exists in a bidding process of the bidding event;
generating a third signature based on the verification conclusion and using the additional encrypted information;
transmitting the third signature to the management device; and
transmitting identity information of the bidding event to the management device.
